(19) United States
(12) Patent Application Publication
(10) Pub. No.: US 2010/0186274 A1
(43) Pub. Date: Jul. 29, 2010

(54) IDENTIFICATION BANDS FOR FOLDED LINENS

(76) Inventor: Karyn Diehl, Lilydale, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 12/691,795

(22) Filed: Jan. 22, 2010

Related U.S. Application Data
(60) Provisional application No. 61/146,692, filed on Jan. 23, 2009.

(51) Int. Cl. G09F 3/10; G09F 3/00; G09F 3/04

(52) U.S. Cl. 40/638; 40/299.01

(57) ABSTRACT

An identification band for folded linens. The identification band includes a strip of material removably disposable around the folded linen and having identifying indicia displayed on the strip of material which identifies an intended use of the folded linen.

### BACKGROUND

Most households and hotels have multiple beds of different sizes. For example, a household master bedroom or a hotel suite may have a king sized bed, whereas a household guest room or standard hotel room may have a queen or a full sized bed, and a children's bedroom may have a full or twin bed. Each of these different sized beds require different sized bed linens, such as bed sheets, bed covers, duvets, duvet covers and the like. After washing, the different sized bed linens are typically folded and stacked together for storage in a closet or drawer until needed on the beds.

When it is time to use the bed linens on a bed, it is often difficult to determine and select the proper size bed linen from the folded stack and it is extremely frustrating when changing bed linens to find out that you are trying to fit a double bed sheet to a queen bed, because you not only have the extra work required to refold the linen, you also have to return to the closet or drawer and make another guess as to which linen in the stack is the right size for the bed. Accordingly, it would be desirable to secure by a means that is quickly and easily removable, a band to identify the size of the linens or sets of bed linens to eliminate the foregoing frustration experienced by homemakers, house keepers, maids, hotel staff or anyone else who changes bed linens regularly, by taking the guesswork out of choosing the correct linens for the corresponding bed size. A similar band would also be desirable for table linens or any other article that, when folded and placed among similar articles, the size or intended use is difficult to discern.

### DESCRIPTION OF THE DRAWINGS

FIG. 1 is a perspective view showing a stack of individual folded bed linens with each individual folded bed linen having a band around it with indicia indicating the size of the bed linen.

FIG. 2 illustrates a set of folded bed linens, such as a pillow case, a flat sheet and a fitted sheet, with a band around the set with indicia indicating the bed size on which the set is intended to be used.

FIG. 3 illustrates a folded table linen having a band around it with indicia indicating the size of the table linen.

FIG. 4 illustrates a folded linen, such as a down comforter or blanket, with a band indicating the size of the bed for which it is intended to be used.

FIG. 5 illustrates an embodiment of a linen band in the unused condition as viewed from the back side with an adhesive strip on one end which adheres proximate the other end when forming a band around the folded linen.

FIG. 6 illustrates another embodiment of a linen band in the unused condition as viewed from the back side with hook and loop fastener strips on opposing ends when forming a band around the folded linen.

FIG. 7 illustrates another embodiment of a linen band in the unused condition as viewed from the back side in which one end is insertable into an opening in the other end when forming a band around the folded linen.

FIG. 8 is a perspective view of another embodiment of a linen band in which the band is preformed in a loop.

FIG. 9 illustrates an embodiment of a multi-ply sheet with removable linen bands with different bed size indicia preprinted thereon.

FIG. 10 illustrates an embodiment in which the strips for forming the linen bands are arranged in a stack with one re-adhereable or re-positionable adhesive on one end or both ends similar to Post-it® notes such that individual strips may be removed from the stack and used to form a band by re-adhering the overlapping ends.

FIG. 11 illustrates another embodiment in which the strips for forming the linen bands are formed in a continuous roll with perforations or break points spaced along the continuous strip at predetermined lengths so a strip of a desired length can be easily removed from the continuous roll.

### DETAILED DESCRIPTION

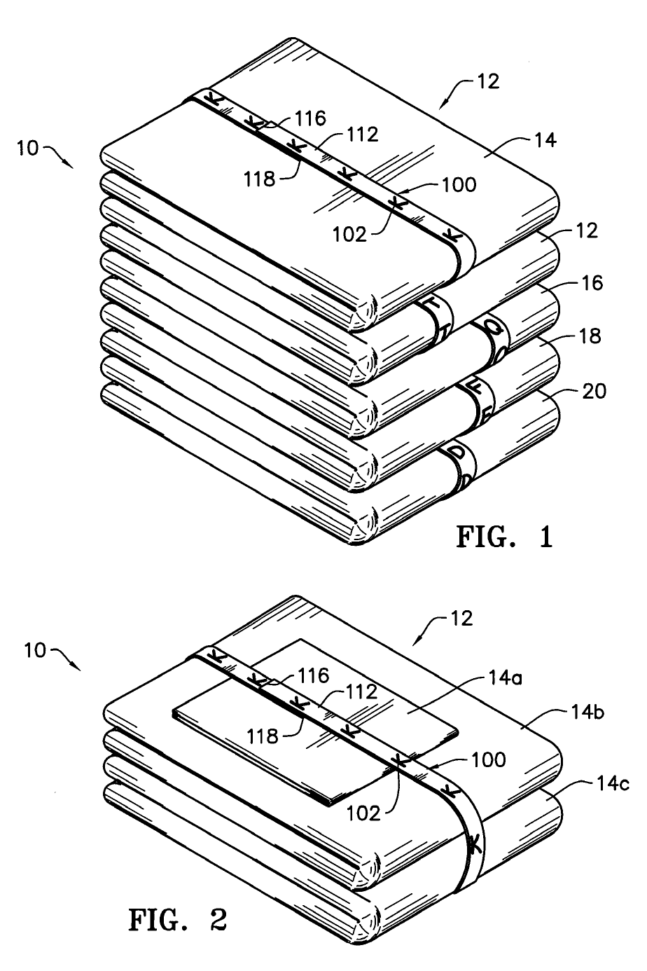

Referring now to the drawings, wherein like reference numerals designate identical or corresponding parts throughout the several views, FIG. 1 is a perspective view showing a stack 10 of folded linens 12. As used herein, the term “linens” should be understood to include and refer to any bed sheets, blankets, bed covers, pillow covers, duvets, duvet covers, table linens, or any other item, the size of which is difficult to discern when folded and placed among similar items. As used herein the term “linens” should also be understood to refer to either individual items or sets of items, for example a set of bed linens comprising pillow covers, flat sheets and fitted sheets, for a particular size bed.

In the embodiment of FIG. 1, the stack 10, as shown, includes linens 12 for different sizes of beds, including king 14, queen 16, full 18, double 20, and twin 22. Disposed around each of the folded linens 12 in the stack 10 is a band 100. The band 100 includes identifying indicia 102 preferably comprising printed words or symbols identifying the corresponding bed size on which the linen is intended to be used, or location where the linen is intended to be used. For example, for king sized bed linens, the word “King” or letter “K” could be identified on the band. Similarly, “Queen” or “Q”, “Full” or “F”, “Double” or “D” and “Twin” or “T” or actual dimensions for the linens could be identified on the band for the corresponding bed size. Other suitable identifying indicia 102 may include coloring, images or other graphics. Additionally, rather than indicating size, the identifying indicia may identify a location, or other intended use for the linen. For example the indicia may indicate “Kitchen”, “Master Bath”, “Master Bed”, etc.

The identifying indicia 102 may be pre-printed on the band 100 or the identifying indicia 102 may be written on the band 100 by hand using a marker or the like prior to placing around the linen 12. It is contemplated that the band 100 is to be placed around the linen 12 after being washed and promptly after folding. It is also preferable that the identifying indicia 102 be large enough such that it is easily readable or discernable from a distance even in low lighting conditions as is typical of most household closets, drawers or storage rooms. Additionally, the bands 100 may be infused with scent to provide a pleasing aroma to the linens while in storage.

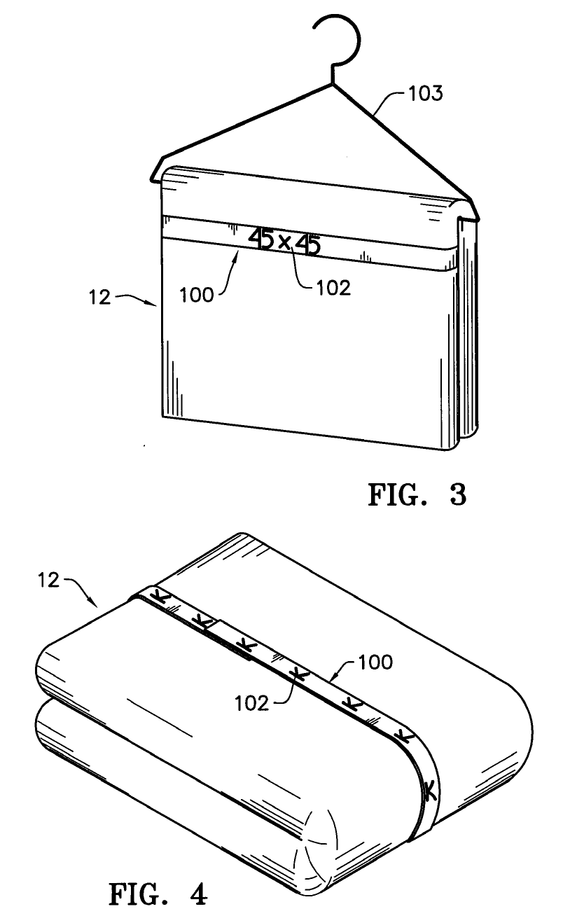

FIG. 2 illustrates a set of folded bed linens 12, such as a pillow case, a flat sheet and a fitted sheet, with the band 100 around the set with indicia 102 indicating the bed size (“K” or “King”) on which the set is intended to be used. FIG. 3 illustrates a table linen 12, folded over a hanger with the band 100 marked with indicia 102 indicating the size of the table linen. FIG. 4 illustrates a folded linen, such as a down comforter or blanket, with the band 100 marked with indicia 102 indicating the size of the bed for which it is intended to be used.

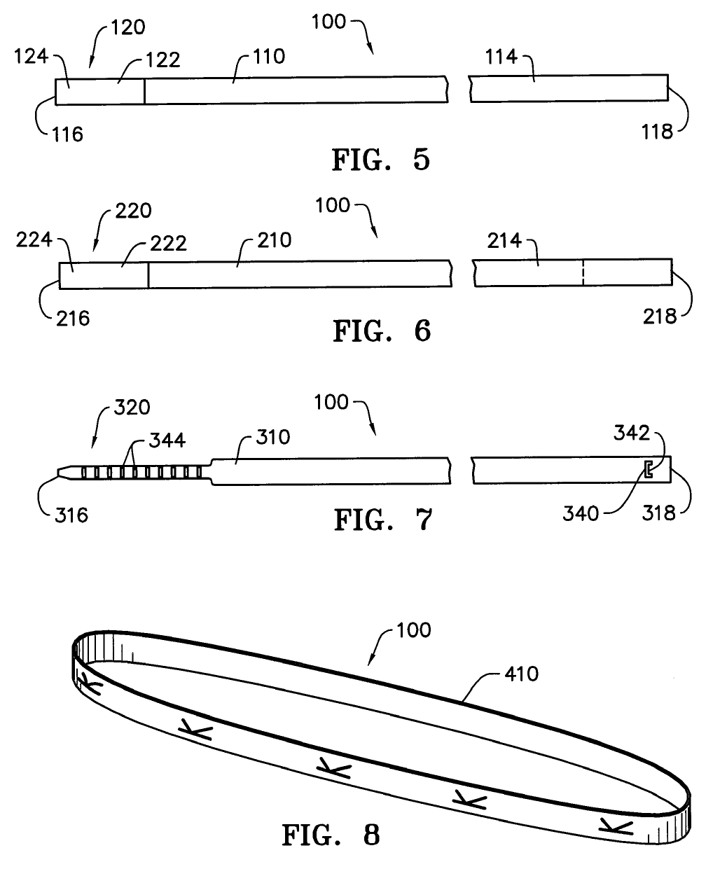

FIG. 5 illustrates one embodiment of the band 100. In this embodiment, the band 100 is an elongated strip 110 of material having a front side 112 (FIG. 1), a back side 114 and opposing ends 116, 118. So that the identifying indicia 102 on the strip 110 is sufficiently large to be readily discernable under low light conditions, the strip 110 is preferably approximately two inch in width with the identifying indicia 102 printed or printable thereon and preferably being only slightly less than that width. Of course, narrower or wider dimensions of the strip 110 and identifying indicia 102 may be equally suitable depending on the user's preference or other conditions.

The strip 110 is also preferably of a sufficient length to wrap around the linen 12 when folded while still allowing some overlap of the ends 116, 118. For example, a strip 110 of approximately thirty six inches in length should be sufficient to wrap around most folded bed linens. Of course the dimensions of the band 100 may vary as desired depending on the size of the linen, the number and size of folds made, the type of material and the thickness of the material comprising the linens, the amount and size of indicia 102 desired, etc. Additionally, as described below, securing means 120 may be used to adjust the band to any desired size.

The strip 110 preferably includes some type of securing means 120 to secure or hold the overlapping ends 116, 118 together. The securing means 120 may allow the ends 116, 118 to be removable or separable, or the securing means 120 may be such that the ends are more or less permanently affixed to one another. For example, as illustrated in FIG. 5, the securing means 120 may include an adhesive area 122 on the back side 114 of one end 116 which is exposed upon the removal of a tab 124. The exposed adhesive area 122 can then be fixedly adhered to the front side 112 of the strip 110. Alternatively, the ends 116, 118 of the strip 110 may be provided with re-adhereable or re-positionable adhesive, such as the type of adhesive used with Post-It® notes, which allows the ends 116, 118 of the strip 110 to be positioned and adhered in overlapping relation to form the band 100 of the desired size.

In the embodiment of FIG. 5, the band 100 would be a single use disposable band. The material comprising the strip 110 is preferably paper, plastic or any other suitable material. In a preferred embodiment, the band 100 is made of material that will not easily tear or break when being placed around the folded linen 12 or during movement of the folded linens such as when being placed into or being retrieved from storage. However, at the same time, it may be desirable for the strip 110 to be capable of being torn or broken if desired without undue effort upon the application of a specific force for the purpose thereof.

FIG. 6 illustrates another embodiment of the band 100 wherein the strip 210 includes a securing means 220 comprising a hook-and-loop fastener, such as Velcro®, to permit the band 100 to be reusable. In this embodiment, the back side 214 of one end 216 of the strip 210 may include the hook portion 230 and the front side 212 may include a loop portion 232 to which the hook portion 230 is removably and repeatedly attachable. Thus, in this embodiment, the band 100 would be reusable. The material comprising the strip 210 is preferably paper, vinyl, plastic or other material that will not easily tear or break when being placed around the folded linen 12 or during movement of the folded bed linens such as when being placed into or being retrieved from storage.

FIG. 7 illustrates yet another embodiment of the band 100 wherein the strip 310 includes a securing means 320 wherein one end 316 of the strip 310 is insertable into an opening 340 in the other end 318 of the strip, such that the ends are interlockably engaged. The band 100 can be drawn securely around the folded linen 12 by pulling the one end 316 through the opening 340 until the tab 342 extending into the opening 340, interlockably engages a desired one of the plurality of apertures 344 along the length of the strip 310. In this embodiment, the band 100 may be disposable or reusable. Again, the material comprising the strip 310 is preferably paper, vinyl, plastic or other material that will not easily tear or break when being placed around the folded linen 12 or during movement of the folded linens such as when being placed into or being retrieved from storage.

FIG. 8 illustrates a band 100 comprising a continuous strip 410. In this embodiment, the strip 410 is sized to be slightly less than the anticipated size of the folded linen 12 on which it is to be used. Again, the material comprising the strip 410 is preferably of a material that will not easily tear or break when being placed around the folded linen 12 or during movement of the folded linens such as when being placed into or being retrieved from storage. However, it is also preferable that the strip 410 in this embodiment also has some degree of elasticity so that it can be stretched for easier placement around the folded linen 12, but when released, it returns to its unstretched size as previously described. Accordingly, the strip 410 may be a stretchable fabric or elastic or rubber band or it may be a combination of a non-stretchable paper or plastic portion and a stretchable material. In this embodiment, the band 100 may be disposable or reusable. As previously described, the continuous strip 410 may be pre-printed with the identifying indicia 102 or the continuous strip 410 may be blank to permit the identifying indicia 102 to be written on the blank continuous strip 410 by hand using a pen, marker, or the like.

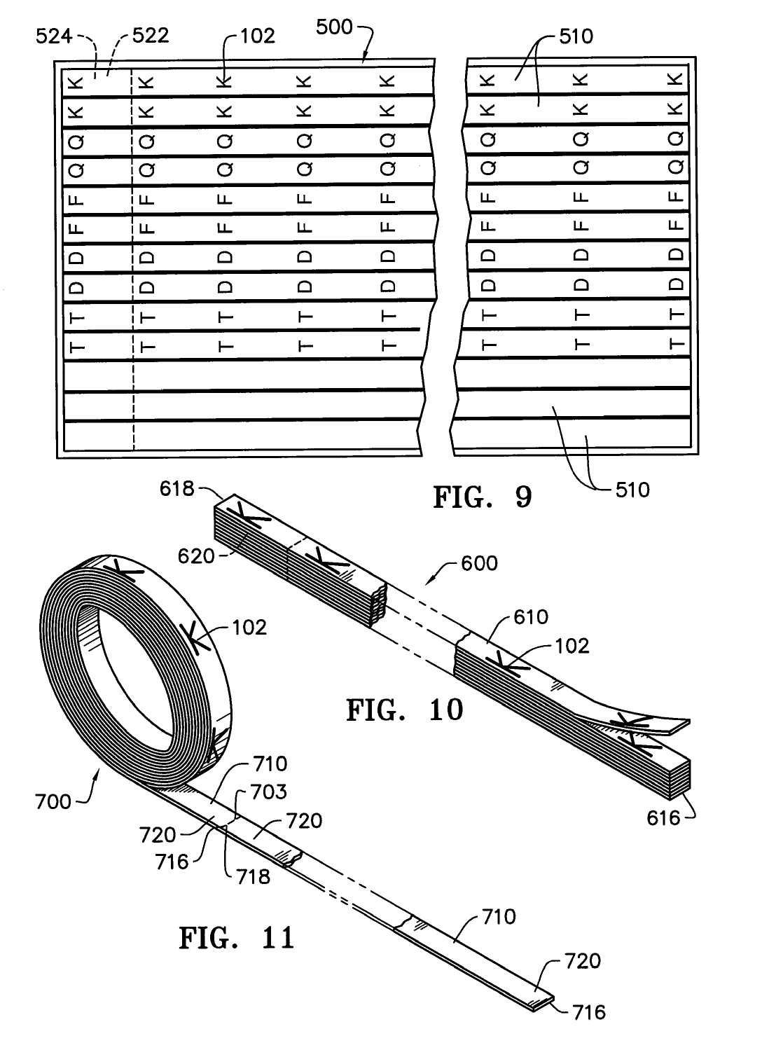

FIG. 9 illustrates an embodiment of a multi-ply sheet 500 having a plurality of readily removable strips 510 for forming the linen bands 100 with identifying indicia 102 printed thereon. Each of the removable strips 510 include an adhesive backed portion 522 with a separately removable tab 524 as previously described in connection with FIG. 5. Each of the strips 510 in the multi-ply sheet 500 may be pre-printed with the same identifying indicia 102 or the strips 510 may have a variety of identifying indicia 102 printed thereon as shown in FIG. 9. Alternatively, the strips 510 in the multi-ply sheet 500 may be blank to permit the identifying indicia 102 to be printed using a conventional laser jet, bubble jet or other type of printer, or the identifying indicia 102 may be written on the blank strips 510 by hand using a pen, marker, or the like.

FIG. 10 illustrates an embodiment in which the strips 610 for forming the linen bands 100 are arranged in a stack 600 with the strips 610 having re-adhereable or re-positionable adhesive on the back side 614 of one end or both ends 616, 618 to provide the securing means 620 for forming the band 100. The stack 600 of strips 610 would be similar to elongated Post-it® notes permitting the individual strips 610 to be removed from the stack 600 and used to form a band 100 around the folded linen 12 by re-adhering the overlapping ends 616, 618. The individual strips 610 within the stack 600 may be pre-printed with the identifying indicia 102 or the strips 610 may be blank to permit the identifying indicia 102 to be written on the blank strips 610 by hand using a pen, marker, or the like.

FIG. 11 illustrates yet another alternative embodiment in which the strips 710 are formed in a continuous roll 700 with perforations or break points 703 spaced at predetermined lengths so that individual strips 710 of a desired length can be easily removed from the continuous roll 700. Additionally, depending on the securing means desired, the continuous roll 700 could have spaced securing means 720 adjacent the perforation or break point 701 so that upon removal of the desired strip length, at least one end of the removed strip 710 would include some means for securing the ends of the strip 710 together to form a band. For example, with an adhesive securing means as previously described in connection with FIG. 5, an adhesive area may be provided adjacent the perforation or break point 703. In such an embodiment, the adhesive area may not need a removable tab, because the adhesive area would be covered by the adjacent strip layer in the roll. Alternatively, re-adhereable or re-positionable adhesive may be used adjacent the perforation or break point 703, such as the type used on Post-It® notes, thereby eliminating the need for removable tabs. Alternatively, with a hook and loop securing means as previously described in connection with FIG. 6, the continuous strip could be provided with a hook or loop portion adjacent the perforation or break point 703 to mate with the corresponding loop or hook portion at the other end of the strip 710 as previously described in connection with FIG. 6. Alternatively, with the tab and aperture securing means as previously described in connection with FIG. 7, one end of the strip 710 on one side of the perforation or break point 703 could include the opening and tab and the other end of the strip on the other side of the perforation or break point 703 could include the apertures extending a distance along the length, such that each strip 710 when removed from the roll 700 will have the two cooperating ends as previously described in connection with FIG. 7. The individual strips 710 comprising the continuous roll 700 may be pre-printed with the identifying indicia 102 or the strips 710 may be blank to permit the identifying indicia 102 to be written on the blank strips 710 by hand using a pen, marker, or the like.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. An identification band for folded linens, comprising:
a strip of material forming a band removably disposed around a folded linen;
identifying indicia displayed on said strip of material, said identifying indicia identifying an intended use of the folded linen.

2. The identification band of claim 1 wherein said strip of material includes first and second ends securable to form said band.

3. The identification band of claim 1 wherein said strip of material is a continuous band that includes at least a partially elastic portion.

4. The identification band of claim 2 wherein said first and second ends are securable by an adhesive in an overlapping relation to form said band.

5. The identification band of claim 4 wherein said adhesive is a re-adhereable adhesive.

6. The identification band of claim 2 wherein said first and second ends are securable by hook and loop fasteners in an overlapping relation to form said band.

7. The identification band of claim 2 wherein said first and second ends are securable by interlockably engaging to form said band.

8. The identification band of claim 1 further comprising a securing means for securing first and second ends of said strip together to form said band.

9. The identification band of claim 1 wherein said identifying indicia is pre-printed on said strips.

10. The identification band of claim 1 wherein said strips are blank and said identifying indicia is printed on said strips by a user using a printer.

11. The identification band of claim 1 wherein said strips are blank and said identifying indicia is written on said strips by a user.

12. The identification band of claim 4 wherein said strip is removable from a stack of a plurality of like strips.

13. The identification band of claim 5 wherein said strip is removable from a stack of a plurality of like strips.

14. The identification band of claim 8 wherein said strip is removable from a stack of a plurality of like strips.

15. The identification band of claim 2 wherein said strip is removable from a continuous roll.

16. The identification band of claim 4 wherein said strip is removable from a continuous roll.

17. The identification band of claim 5 wherein said strip is removable from a continuous roll.

18. The identification band of claim 6 wherein said strip is removable from a continuous roll.

19. The identification band of claim 7 wherein said strip is removable from a continuous roll.

20. The identification band of claim 8 wherein said strip is removable from a continuous roll.

21. Bands for identifying folded linens, comprising:
a plurality of elongated strips of material arranged such that each one of said plurality of elongated strips is removable from a remainder of said plurality of elongated strips, each one of said plurality of elongated strips having first and second ends securable to form a band around the folded linens and further wherein each one of said plurality of elongated strips includes indicia displayed thereon identifying an intended use of the folded linens.

22. The bands of claim 21 wherein said plurality of elongated strips are arranged in a stack.

23. The bands of claim 21 wherein said plurality of elongated strips are arranged in a continuous roll.

24. The bands of claim 23 wherein said plurality of elongated strips are arranged in a sheet.
